(19) United States
(12) Patent Application Publication
(10) Pub. No.: US 2019/0283755 A1
(43) Pub. Date: Sep. 19, 2019

(54) CONTROL DEVICE FOR VEHICLE AND CONTROL METHOD FOR VEHICLE

(71) Applicant: JATCO Ltd, Fuji-shi, Shizuoka (JP)

(72) Inventors: Yoshimasa NISHIHIRO, Zama-shi, Kanagawa (JP); Yusuke OOTA, Ebina-shi, Kanagawa (JP); Shintaro OHSHIO, Atsugi-shi, Kanagawa (JP)

(73) Assignee: JATCO Ltd, Fuji-shi, Shizuoka (JP)

(21) Appl. No.: 16/319,274

(22) PCT Filed: Jun. 21, 2017
(86) PCT No.: PCT/JP2017/022864

§ 371 Date: Jan. 18, 2019

(30) Foreign Application Priority Data
Jul. 19, 2016 (JP) 2016-141581

(51) Int. Cl. B60W 30/18; B60W 10/06; B60W 10/02; F02D 29/02; F16H 59/74; F16H 61/00

(52) U.S. Cl. CPC B60W 30/18072; B60W 10/06; B60W 10/023; B60W 10/02; F02D 29/02; F16H 59/74; B60Y 2300/192; B60W 2710/0644; B60W 2030/1809; B60W 2710/0627; B60W 2710/024; B60Y 2300/18083; F16H 61/00

(57) ABSTRACT

A transmission controller increases a load applied on an engine when a start condition of a sailing-stop control is met.

### TECHNICAL FIELD

The present invention relates to a control device for a vehicle and a control method for a vehicle.

### BACKGROUND ART

Conventionally, a sailing-stop control which brings an automatic transmission to neutral (power shut-off state) when the following conditions (a) to (d) are met and stops an engine has been known.

(a) D (forward) range is selected;

(b) A vehicle speed is a set vehicle speed or more (meddle to high vehicle speed);

(c) An accelerator pedal is not stepped on (Accelerator OFF); and

(d) A brake pedal is not stepped on (Brake OFF).

Such technology is disclosed in JP2013-213557A, as free-run, for example.

### SUMMARY OF INVENTION

When the sailing-stop control is to be executed, it is preferable that an engine rotation speed is maintained at a predetermined rotation speed (an idle rotation speed, for example) so as to make an oxygen storage amount of an exhaust purification catalyst proper as an exhaust measure and then, an engine is stopped.

However, if the engine rotation speed immediately before the sailing-stop control is to be executed is higher than the predetermined rotation speed, it takes time for the engine rotation speed to lower to the predetermined rotation speed and thus, start timing of the sailing-stop control is delayed.

The present invention was made in view of such technical problem and has an object to expedite the start timing of the sailing-stop control.

According to one aspect of the present invention, a control device for a vehicle including an engine and an automatic transmission having a power transmission mechanism, the control device includes a control unit configured to maintain a rotation speed of the engine at a predetermined rotation speed and then, to stop the engine when a sailing-stop control which stops the engine and disengages an engagement element provided in the power transmission mechanism is to be executed during running of the vehicle, wherein the control unit is configured to increase a load applied on the engine when a start condition of the sailing-stop control is met.

According to another aspect of the present invention, a control method for a vehicle including an engine and an automatic transmission having a power transmission mechanism, the control method includes maintaining a rotation speed of the engine at a predetermined rotation speed and then, stopping the engine when a sailing-stop control which stops the engine and disengages an engagement element provided in the power transmission mechanism is to be executed during running of the vehicle; and increasing a load applied on the engine when a start condition of the sailing-stop control is met.

In these aspects, when the start condition of the sailing-stop control is met, a load applied on the engine is increased. According to this, lowering of the engine rotation speed can be expedited. Thus, the start timing of the sailing-stop control can be expedited.

### BRIEF DESCRIPTION OF DRAWINGS

FIG. 1 is a schematic configuration diagram of a vehicle according to an embodiment of the present invention.

FIG. 2 is a flowchart illustrating contents of processing executed by a controller.

FIG. 3 is a time chart when a sailing-stop control is started.

### DESCRIPTION OF EMBODIMENTS

Hereinafter, an embodiment of the present invention will be described by referring to the attached drawings.

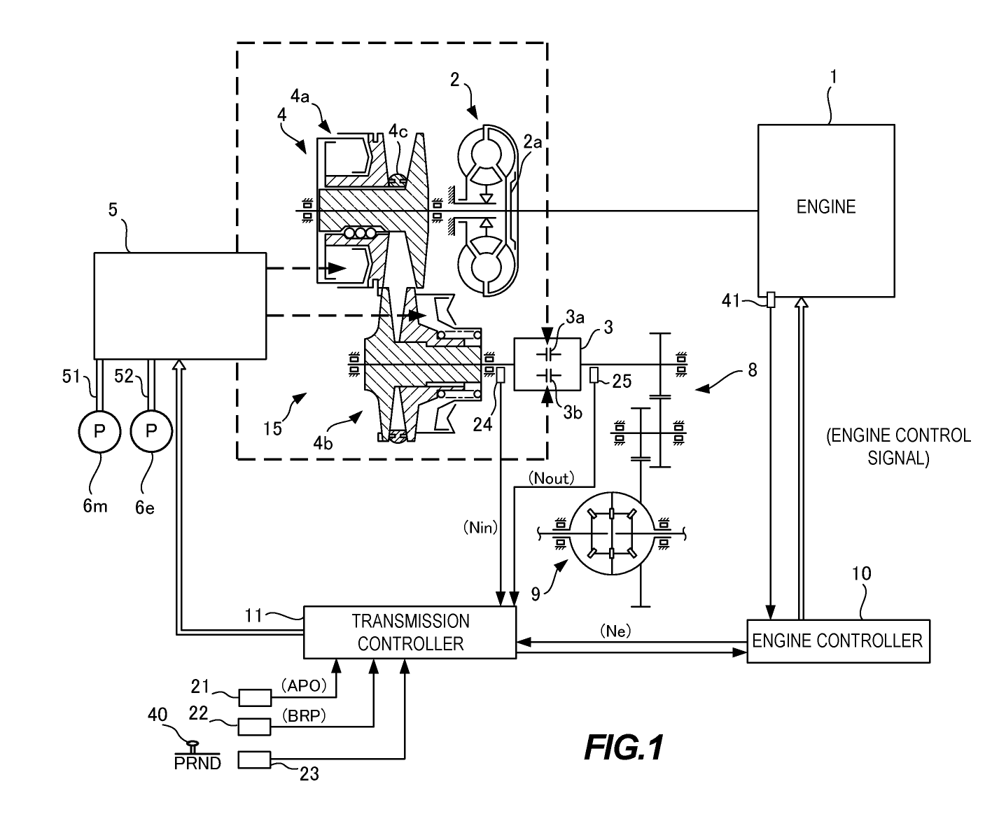

FIG. 1 is a schematic configuration diagram of a vehicle according to the embodiment of the present invention. The vehicle includes an engine 1, a torque converter 2, a continuously variable transmission 4 as a variator, a forward/reverse switching mechanism 3 as a power transmission mechanism, a hydraulic control circuit 5, a first oil pump 6m, a second oil pump 6e, an engine controller 10, and a transmission controller 11. In the vehicle, rotation generated in the engine 1 is transmitted to a wheel, not shown, through the torque converter 2, the continuously variable transmission 4, the forward/reverse switching mechanism 3, a gear train 8, and a differential gear device 9. An automatic transmission 15 is constituted by the torque converter 2, the continuously variable transmission 4, and the forward/reverse switching mechanism 3.

The torque converter 2 has a lockup clutch 2a, and when the lockup clutch 2a is engaged, an input shaft and an output shaft of the torque converter 2 are directly connected, and the input shaft and the output shaft are rotated at the same speed.

The continuously variable transmission 4 includes a primary pulley 4a, a secondary pulley 4b, and a belt 4c wound around the primary pulley 4a and the secondary pulley 4b. In the continuously variable transmission 4, when a hydraulic pressure Pp supplied to the primary pulley 4a and a hydraulic pressure Ps supplied to the secondary pulley 4b are controlled, a contact radius between each of the pulleys 4a, 4b and the belt 4c is changed, whereby a speed ratio is changed.

The forward/reverse switching mechanism 3 includes a forward clutch 3a and a reverse brake 3b as engagement elements, input rotation from the continuously variable transmission 4 is output as it is at engagement of the forward clutch 3a, and the input rotation from the continuously variable transmission 4 is reversed/decelerated and output at the engagement of the reverse brake 3b.

The first oil pump 6m is a mechanical oil pump to which the rotation of the engine 1 is input and driven by using a part of power of the engine 1. Oil discharged from the first oil pump 6m by the driving of the first oil pump 6m is supplied to the hydraulic control circuit 5 through an oil path 51 as a line-pressure supply oil path connected to a discharge port of the first oil pump 6m. When the engine 1 is stopped, the first oil pump 6m is not driven, and the oil is not discharged from the first oil pump 6m.

The second oil pump 6e is an electric oil pump to which electricity is supplied from a battery and driven. An oil path 52 is connected to a discharge port of the second oil pump 6e. The oil can be supplied to the hydraulic control circuit 5 even while the engine is stopped by driving the second oil pump 6e when the first oil pump 6m is not driven.

The hydraulic control circuit 5 is constituted by a plurality of paths, a plurality of hydraulic actuators and the like. The hydraulic actuator is constituted by a solenoid and a hydraulic control valve. In the hydraulic control circuit 5, the hydraulic actuator is controlled on the basis of a control signal from the transmission controller 11 so as to switch a supply path of the hydraulic pressure, and a required hydraulic pressure is prepared from a line pressure PL generated by the oil discharged from the first oil pump 6m and the second oil pump 6e. The hydraulic control circuit 5 supplies the prepared hydraulic pressure to each portion of the continuously variable transmission 4, the forward/reverse switching mechanism 3, and the torque converter 2.

The transmission controller 11 is constituted by a CPU, a ROM, a RAM and the like. In the transmission controller 11, a function of the transmission controller 11 is exerted when the CPU reads out and executes a program stored in the ROM.

A signal from an accelerator pedal opening sensor 21 adapted to detect an accelerator pedal opening APO, a signal from a brake fluid pressure sensor 22 adapted to detect a brake fluid pressure BRP corresponding to an operation amount of a brake pedal, a signal from an inhibitor switch 23 adapted to detect a position of a shift lever 40 are input into the transmission controller 11. Moreover, a signal from a rotation speed sensor (not shown) adapted to detect a rotation speed on an input side (a side of the torque converter 2) of the continuously variable transmission 4, a signal from an input-side rotation speed sensor 24 adapted to detect a rotation speed Nin on the input side (a side of the continuously variable transmission 4) of the forward/reverse switching mechanism 3, a signal from an output-side rotation speed sensor 25 adapted to detect a rotation speed Nout on an output side (a side of the gear train 8) of the forward/reverse switching mechanism 3, a signal from a rotation speed sensor 41 adapted to detect a rotation speed Ne of the engine 1 and the like are input into the transmission controller 11.

The transmission controller 11 and the engine controller 10 are capable of communication with each other. The transmission controller 11 and the engine controller 10 may be integrated to make one controller.

In this embodiment, when the sailing-stop control start condition is met during running of the vehicle, fuel injection to the engine 1 is stopped so as to stop the engine 1, and the sailing-stop control in which the forward clutch 3a and the reverse brake 3b are disengaged in the forward/reverse switching mechanism 3 and a neutral state is brought about is executed.

As a result, an inertia running distance in a state where the engine 1 is stopped becomes longer, and fuel efficiency of the engine 1 can be improved.

The sailing-stop control start conditions are following conditions, for example:

(a) D(forward) range is selected by the shift lever 40;

(b) A vehicle speed VSP is a set vehicle speed or more;

(c) The accelerator pedal is not stepped on (Accelerator OFF); and

(d) The brake pedal is not stepped on (Brake OFF).

The set vehicle speed is a middle-to-high vehicle speed and is set in advance.

The sailing-stop control start condition is met when all the aforementioned conditions (a) to (d) are satisfied, and when any one of the aforementioned (a) to (d) is not satisfied, it is not met.

If the sailing-stop control start condition is no longer met during the sailing-stop control, the sailing-stop control is cancelled, the engine 1 is started, and the forward clutch 3a is engaged. That is, the sailing-stop control start condition is also a sailing-stop control cancellation condition for cancelling the sailing-stop control. The sailing-stop control start condition may be a condition different from the sailing-stop control cancellation condition. Execution and cancellation of the sailing-stop control is executed by the transmission controller 11.

When the sailing-stop control is to be executed, it is preferable that the engine rotation speed Ne is maintained at a predetermined rotation speed (an idle rotation speed, for example) so as to make an oxygen storage amount of an exhaust purification catalyst (not shown) proper as an exhaust measure and then, the engine 1 is stopped.

However, if the engine rotation speed Ne immediately before the sailing-stop control is executed is higher than the predetermined rotation speed, it takes time for the engine rotation speed Ne to lower to the predetermined rotation speed and thus, start timing of the sailing-stop control is delayed.

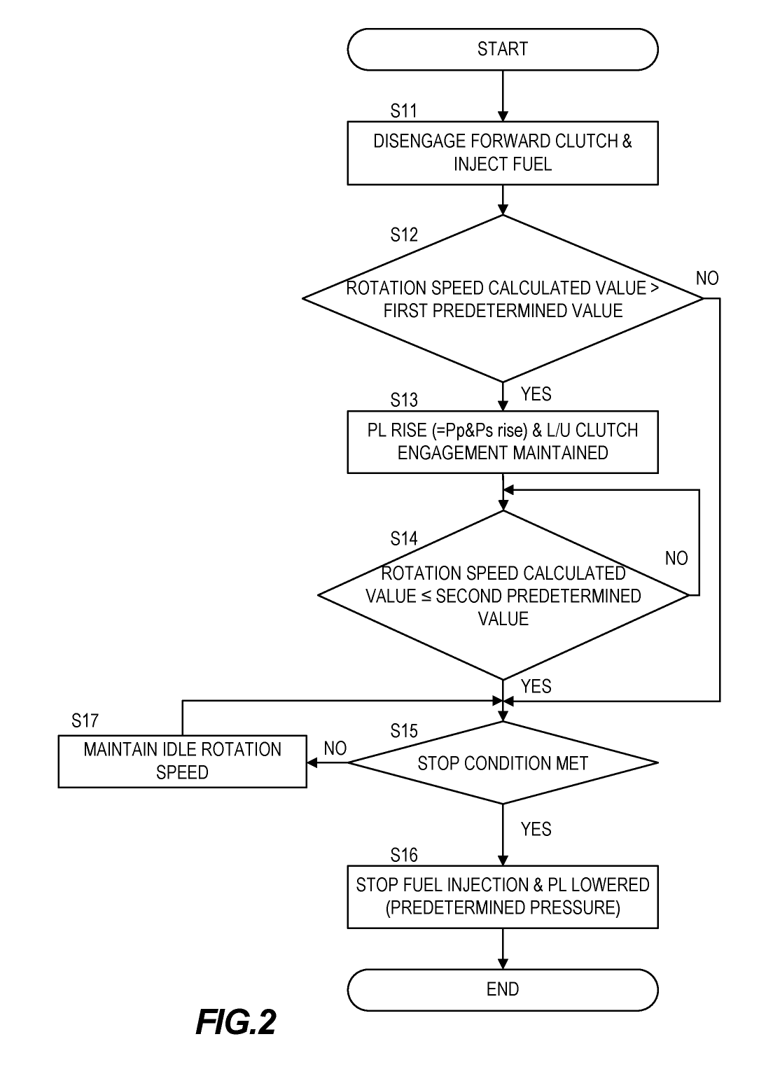

Thus, the transmission controller 11 of this embodiment starts the sailing-stop control in accordance with a procedure illustrated in a flowchart in FIG. 2 when the sailing-stop control start condition is met in order to expedite the start timing of the sailing-stop control.

Hereinafter, contents of the processing executed by the transmission controller 11 when the sailing-stop control start condition is met will be described by referring to FIG. 2. In this embodiment, the predetermined rotation speed is the idle rotation speed.

At Step S11, the transmission controller 11 disengages the forward clutch 3a and issues an instruction to the engine controller 10 to continuously inject a small amount of a fuel. As a result, the rotation speed Ne of the engine 1 is lowered.

The forward clutch 3a is disengaged when the hydraulic pressure Pf supplied to the forward clutch 3a from the hydraulic control circuit 5 by a disengagement instruction from the transmission controller 11 is lowered. The disengagement instruction corresponds to a current change instruction to a control solenoid valve in order to lower a clutch pressure of the forward clutch 3a, for example.

At Step S12, the transmission controller 11 determines whether a value (hereinafter, referred to as a rotation speed calculated value) obtained by subtracting the idle rotation speed as the predetermined rotation speed from the engine rotation speed Ne is larger than a first predetermined value or not. The first predetermined value is 300 rpm, for example.

When the transmission controller 11 determines that the rotation speed calculated value is larger than the first predetermined value, it moves the processing to Step S13. Moreover, if it determines that the rotation speed calculated value is not larger than the predetermined value, it moves the processing to Step S15.

At Step S13, the transmission controller 11 raises the line pressure PL and maintains the engaged state of the lockup clutch 2a.

At this point of time, since the first oil pump 6m is driven by remaining rotation of the engine 1, the line pressure PL can be adjusted. Here, if the line pressure PL is raised, hydraulic resistance at the discharge port of the first oil pump 6m is increased, and a rotation load of the first oil pump 6m is increased. As a result, since the load applied on the engine 1 increases, lowering of the engine rotation speed Ne can be expedited.

Moreover, in this embodiment, the line pressure PL can be directly supplied to the primary pulley 4a and the secondary pulley 4b as the hydraulic pressure Pp and the hydraulic pressure Ps. Thus, the hydraulic pressures Pp and Ps can be raised, respectively, by raising the line pressure PL.

In general, when the hydraulic pressures Pp and Ps supplied to each of the pulleys 4a and 4b are raised and a sandwiching force of each of the pulleys 4a and 4b increases, energy loss is increased by friction generated between the belt 4c and each of the pulleys 4a, 4b. Since power transmission from the engine 1 to each of the pulleys 4a and 4b is carried out until the engine 1 is stopped, lowering of the engine rotation speed Ne can be expedited by the increase in the energy loss by the friction.

Moreover, by maintaining the engaged state of the lockup clutch 2a, the engine 1, a pump impeller, and a turbine runner are integrally rotated. As a result, a load for rotation inertia of the pump impeller and the turbine runner is applied on the engine 1. Moreover, a friction loss when the pump impeller and the turbine runner are rotated is also generated. Thus, the lowering of the engine rotation speed Ne can be expedited.

At Step S14, the transmission controller 11 determines whether the rotation speed calculated value has become the second predetermined value or less. The second predetermined value is 200 rpm, for example. The first predetermined value and the second predetermined value may be the same value.

When the transmission controller 11 determines that the rotation speed calculated value has become the second predetermined value or less, it moves the processing to Step S15. Moreover, if it determines that the rotation speed calculated value has not become the second predetermined value or less, it repeatedly executes the processing at Step S14.

At Step S15, the transmission controller 11 determines whether the stop condition of the engine 1 has met or not.

The stop condition of the engine 1 is a determination condition on whether or not the oxygen storage amount of the exhaust purification catalyst has been made proper. The stop condition may be set on the basis of elapsed time since the engine 1 has fallen to the idle rotation speed or on the basis of a signal from an O2 sensor (not shown), for example. Moreover, it may be set on the basis on whether a temperature of the exhaust purification catalyst has become a predetermined temperature or more (whether it has been warmed by idling operation).

When the transmission controller 11 determines that the stop condition of the engine 1 is met, it moves the processing to Step S16 as it is considered that the oxygen storage amount of the exhaust purification catalyst has been made proper. Moreover, if it determines that the stop condition of the engine 1 is not met, it maintains the engine rotation speed Ne at the idle rotation speed (Step S17) and repeatedly executes the processing at Step S15.

At Step S16, the transmission controller 11 issues a fuel injection stop instruction to the engine controller 10 so as to cause the fuel injection to be stopped and stops the engine 1. Moreover, the line pressure PL is lowered to a predetermined pressure which can be maintained by driving the second oil pump 6e during the sailing-stop control.

As described above, in this embodiment, if the start condition of the sailing-stop control is met, the load applied on the engine 1 is increased by raising the line pressure PL, by raising the hydraulic pressures Pp and Ps supplied to each of the pulleys 4a and 4b, and by maintaining the engaged state of the lockup clutch 2a.

According to the above, since the lowering of the engine rotation speed Ne can be expedited, the time taken for the engine rotation speed Ne to be lowered to the idle rotation speed can be shortened. Thus, the start timing of the sailing-stop control can be expedited, and fuel efficiency can be improved.

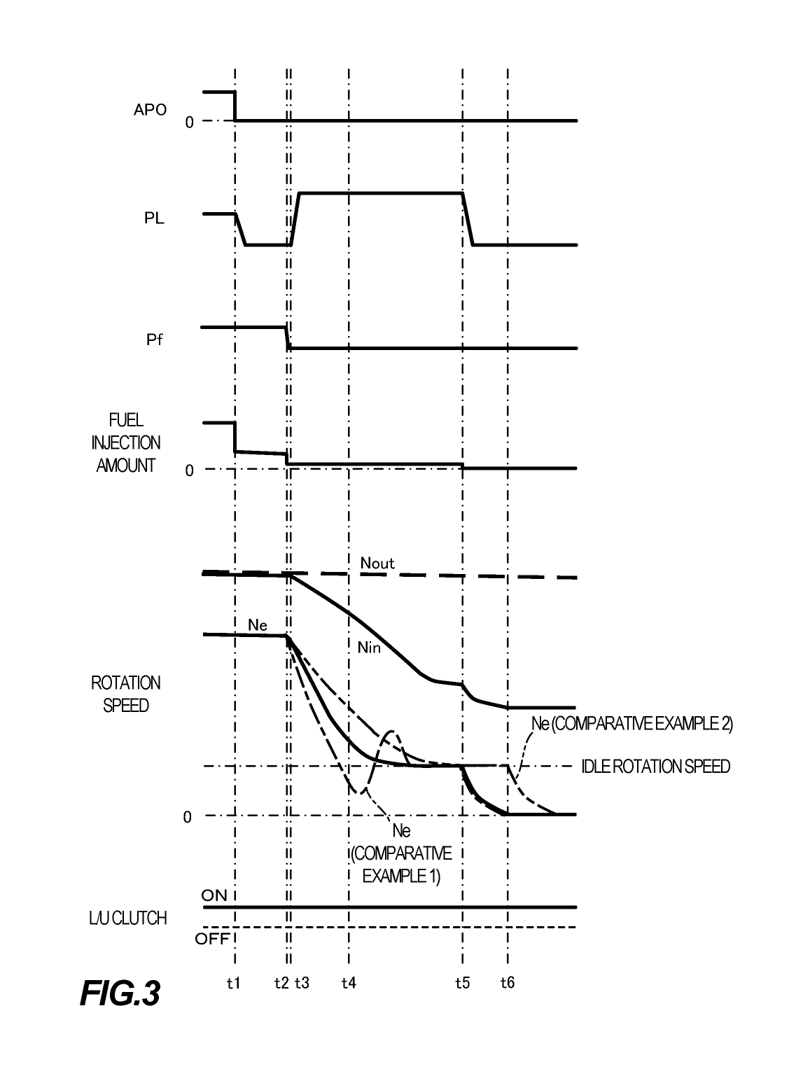

Subsequently, a state where the sailing-stop control is started will be described by referring to a time chart in FIG. 3.

The engine rotation speed Ne (one-dot chain line) illustrates a case as a comparative example 1 in which, when the engine rotation speed Ne is maintained at the idle rotation speed, fuel-cut is performed immediately after start of the sailing-stop control, and the fuel injection is started when the engine rotation speed Ne has come to the vicinity of the idle rotation speed. Moreover, the engine rotation speed Ne (two-dot chain line) illustrates a case as a comparative example 2 in which the fuel is continuously injected and the load applied on the engine 1 is not increased.

When it reaches the Accelerator OFF (APO=0) at time t1, the sailing-stop control start condition is met. Moreover, the fuel injection amount lowers, and the line pressure PL lowers.

At time t2, the hydraulic pressure Pf lowers, the forward clutch 3a is disengaged, and the fuel injection amount becomes small. As a result, the engine rotation speed Ne (solid line) begins to lower. Moreover, a rotation speed Nin on the input side of the forward/reverse switching mechanism 3 lowers with the lowering of the engine rotation speed Ne. The lockup clutch 2a has the engaged state maintained so as to expedite the lowering of the engine rotation speed Ne (L/U clutch ON).

At time t3, the line pressure PL rises. As a result, a rotation load of the first oil pump 6m increases. Moreover, the hydraulic pressure Pp and the hydraulic pressure Ps supplied to the continuously variable transmission 4 rise, and the energy loss is increased by the friction generated between the belt 4c and each of the pulleys 4a, 4b.

At time t4, a value (a rotation speed calculated value) obtained by subtracting the idle rotation speed from the engine rotation speed Ne becomes the second predetermined value or less.

When the engine stop condition is met at time t5, the fuel injection is stopped, and the engine 1 is stopped. Moreover, the line pressure PL lowers to the predetermined pressure.

If the fuel-cut is performed immediately after the start of the sailing-stop control, and the fuel injection is started in the vicinity of the idle rotation speed when the engine rotation speed Ne is maintained at the idle rotation speed as in a comparative example 1, undershoot associated with the fuel-cut and overshoot associated with larger fuel injection occur. Thus, a tachometer becomes unsteady, which gives a sense of discomfort to a driver.

Moreover, in a comparative example 2, inclination during the lowering of the rotation can be made gentler by continuously injecting a small amount of the fuel so that the sense of discomfort is not given to the driver, and the undershoot and the overshoot can be suppressed, but since the load applied on the engine 1 is not increased, the inclination during the lowering of the rotation is made gentler and as a result, the timing when the engine 1 is stopped is delayed to time t6. Thus, injection time of the fuel is increased, whereby fuel efficiency effect is damaged.

On the other hand, by continuously injecting the fuel and by applying a load on the engine 1 as in this embodiment, the sense of discomfort given to the driver is reduced, and the damage on the fuel efficiency effect can be suppressed.

As described above, in this embodiment, the transmission controller 11 increases the load applied on the engine 1 when the start condition of the sailing-stop control is met.

According to this, since the lowering of the engine rotation speed Ne can be expedited, time taken for the engine rotation speed Ne to lower to the idle rotation speed can be shortened. Thus, the start timing of the sailing-stop control can be expedited.

Information that the sailing-stop control has been started is transmitted to the driver as visual information. The visual information is the tachometer, information display and the like, for example. That is, when the sailing-stop control is started, and the engine is stopped, the rotation speed displayed on the tachometer falls to 0.

Moreover, immediately after the sailing-stop control is started, the fact that the sailing-stop control has begun is transmitted in the information display to the driver as visual information (sailing-stop display).

However, if the rotation speed displayed on the tachometer does not fall to 0 regardless of the sailing-stop display (or an engine noise does not disappear), it gives the sense of discomfort to the driver.

Thus, the time from the start of the sailing-stop control to the engine stop is preferably shortened, and according to this embodiment, the time from start of the sailing-stop display to the engine stop can be shortened, and prolongation of time since inertia running is started until the engine rotation number falls to 0 can be suppressed.

Moreover, notification of start of the sailing-stop control simply by the rotation speed display of the tachometer without particular information display can be considered to be made. In such a case, the following effects can be obtained.

That is, when leaving the foot from the accelerator pedal and the inertia running starts, the driver expects the sailing-stop and is assumed to check whether the engine rotation speed Ne has fallen to 0 on the tachometer. However, if the time since the inertia running is started until the rotation speed display on the tachometer falls to 0 is long, it gives an impression to the driver that response of the sailing-stop is slow.

According to this embodiment, in the aforementioned case, too, prolongation of the time since the inertia running is started until the rotation speed display on the tachometer falls to 0 can be suppressed and thus, giving of the impression to the driver that the response of the sailing-stop is slow can be reduced.

Moreover, in this embodiment, while the engine rotation speed Ne is decreasing toward the predetermined rotation speed (the idle rotation speed) from the start of the sailing-stop control, the fuel of the engine 1 is continuously injected.

According to this, by continuously injecting the fuel and by applying the load on the engine 1, the sense of discomfort given to the driver is reduced, while damage on the fuel efficiency effect can be suppressed.

Specifically, the vehicle in this embodiment includes the first oil pump 6m driven by the engine 1 and the oil path 51 connected to the discharge port of the first oil pump 6m and supplying the line pressure PL of the automatic transmission 15, and the transmission controller 11 raises the line pressure PL when the start condition of the sailing-stop control is met.

According to this, hydraulic resistance at the discharge port of the first oil pump 6m increases, and the rotation load of the first oil pump 6m increases. As a result, since the load applied on the engine 1 increases, the lowering of the engine rotation speed Ne can be expedited.

Moreover, the automatic transmission 15 includes the continuously variable transmission 4 having the pair of pulleys 4a, 4b and the belt 4c wound around the pair of pulleys 4a and 4b, and the transmission controller 11 raises the hydraulic pressures Pp and Ps supplied to the pair of pulleys 4a and 4b, respectively, when the start condition of the sailing-stop control is met.

According to this, the sandwiching force of each of the pulleys 4a and 4b increases, and the energy loss is increased by the friction generated between the belt 4c and each of the pulleys 4a, 4b. Power transmission to each of the pulleys 4a and 4b is performed from the engine 1 until the engine 1 is stopped. Thus, since the load applied on the engine 1 is increased by the increase in the energy loss by the friction, the lowering of the engine rotation speed Ne can be expedited.

Moreover, the automatic transmission 15 includes the torque converter 2 having the lockup clutch 2a, and the transmission controller 11 maintains the lockup clutch 2a in the engaged state when the start condition of the sailing-stop control is met.

According to this, the engine 1, the pump impeller, and the turbine runner are integrally rotated. As a result, a load for rotation inertia of the pump impeller and the turbine runner is applied on the engine 1. Moreover, a friction loss when the pump impeller and the turbine runner are rotated is also generated. Thus, the lowering of the engine rotation speed Ne can be expedited.

The embodiment of the present invention has been described, but the aforementioned embodiment illustrates only a part of an application example of the present invention and is not intended to limit the technical scope of the present invention to the specific constitution of the aforementioned embodiment.

For example, in the aforementioned embodiment, the load of the engine 1 is increased by raising the line pressure PL, by raising the hydraulic pressures Pp and Ps supplied to each of the pulleys 4a and 4b, and by maintaining the engaged state of the lockup clutch 2a. However, all of these do not have to be performed at the same time, but the load of the engine 1 can be increased by performing only any one of them.

Moreover, in the aforementioned embodiment, the case where the automatic transmission 15 has the forward/reverse switching mechanism 3 as the power transmission mechanism was described, but the automatic transmission 15 may have a sub-transmission mechanism capable of switching between forward and reverse as the power transmission mechanism.

Moreover, the automatic transmission 15 may be constituted by having a stepped transmission or a toroidal continuously variable transmission, not by the continuously variable transmission 4, as a variator. Even if it has the stepped transmission or the toroidal continuously variable transmission, the energy loss by the friction increases by raising the hydraulic pressure to be supplied, and the lowering of the engine rotation speed Ne can be expedited.

Moreover, in the aforementioned embodiment, the forward/reverse switching mechanism 3 is provided on the downstream side of the continuously variable transmission 4, but the forward/reverse switching mechanism 3 may be provided on the upstream side of the continuously variable transmission 4. In this case, in order to expedite the lowering of the engine rotation speed Ne by raising the hydraulic pressures Ps and Pp supplied to the continuously variable transmission 4, the engaged state of the forward clutch 3a only needs to be maintained until the engine rotation speed Ne has lowered to the idle rotation speed.

With respect to the above description, the contents of application No. 2016-141581, with a filing date of Jul. 19, 2016 in Japan, are incorporated herein by reference.

1-6. (canceled)

7. A control device for a vehicle including an engine and an automatic transmission having a power transmission mechanism, the control device comprising:
a control unit configured to maintain a rotation speed of the engine at a predetermined rotation speed and then, to stop the engine when a sailing-stop control which stops the engine and disengages an engagement element provided in the power transmission mechanism is to be executed during running of the vehicle, wherein
the control unit is configured to increase a load applied on the engine when a start condition of the sailing-stop control is met.

8. The control device for a vehicle according to claim 7, wherein
a fuel of the engine is continuously injected while the rotation speed of the engine is decreasing toward the predetermined rotation speed from start of the sailing-stop control.

9. The control device for a vehicle according to claim 7, wherein
the vehicle includes:
an oil pump driven by the engine; and
a line pressure supply oil path connected to a discharge port of the oil pump and configured to supply a line pressure of the automatic transmission; and
the control unit is configured to raise the line pressure when the start condition of the sailing-stop control is met.

10. The control device for a vehicle according to claim 7, wherein
the automatic transmission includes a variator having a pair of pulleys and a belt wound around the pair of pulleys; and
the control unit is configured to raise a hydraulic pressure supplied to the pair of pulleys, respectively, when the start condition of the sailing-stop control is met.

11. The control device for a vehicle according to claim 7, wherein
the automatic transmission includes a torque converter having a lockup clutch; and
the control unit is configured to maintain the lockup clutch in an engaged state when the start condition of the sailing-stop control is met.

12. A control method for a vehicle including an engine and an automatic transmission having a power transmission mechanism, the control method comprising:
maintaining a rotation speed of the engine at a predetermined rotation speed and then, stopping the engine when a sailing-stop control which stops the engine and disengages an engagement element provided in the power transmission mechanism is to be executed during running of the vehicle; and
increasing a load applied on the engine when a start condition of the sailing-stop control is met.

13. A control device for a vehicle including an engine and an automatic transmission having a power transmission mechanism, the control device comprising:
control means configured to maintain a rotation speed of the engine at a predetermined rotation speed and then, to stop the engine when a sailing-stop control which stops the engine and disengages an engagement element provided in the power transmission mechanism is to be executed during running of the vehicle, wherein
the control means is configured to increase a load applied on the engine when a start condition of the sailing-stop control is met.
